(19) United States
(12) Patent Application Publication
(10) Pub. No.: US 2021/0237264 A1
(43) Pub. Date: Aug. 5, 2021

(54) METHOD AND DEVICES FOR A SMART TRIPOD

(71) Applicants: Eli Altaras, Irvine, CA (US); Yusuf Altaras, Irvine, CA (US)

(72) Inventors: Eli Altaras, Irvine, CA (US); Yusuf Altaras, Irvine, CA (US)

(21) Appl. No.: 16/779,838

(22) Filed: Feb. 3, 2020

(51) Int. Cl. B25J 9/16; H04N 5/232; B25J 9/00

(52) U.S. Cl. CPC B25J 9/162; B25J 9/0003; H04N 5/23218; H04N 5/23203

(57) ABSTRACT

The embodiments disclose a method including creating a smart tripod configured for operating according to user selected command signals and on-board guidance controls including a physical tracking system to track an object and person with a steering system override element, wherein the smart tripod may include self-propelled motorized drive systems, wherein the smart tripod may include coupling devices for attachment to an external self-propelled apparatus, wherein the smart tripod may include a movable luggage integrated telescoping smart tripod, using smart tripod digital controllers to receive and transmit signals for responding to user transmitted signals and digital commands wirelessly for various operations including sound and voice recording, wherein the on-board guidance controls include GPS maneuvering systems and obstacle recognition and avoidance systems, and wherein digital controllers include user face and voice recognition systems.

### BACKGROUND

Conventional tripods used for mounting cameras and other equipment are stationary and require a user to pick up and manually move the tripod to a new location. This can cause for example a photographer to miss a camera shot opportunity. In most instances the user must be physically next to the tripod to snap a picture. Should the user move to a distant location to check for a particular view, or a clear view of an object or for example a wild animal, he must then travel back to the tripod and physically move the tripod and equipment to the new location. What is needed is a smart tripod configured for operating according to user selected command signals and auto-drive on-board guidance controls, with self-propelled motorized drive systems capable of tracking objects and persons including targeted portions of the object or persons, adaptable for attaching to external self-propelled devices including but not limited too movable self-propelled motorized luggage, using smart tripod digital controllers to receive and transmit signals for responding to user transmitted signals and digital commands wirelessly for various operations using a digital device application, wherein the auto-drive on-board guidance controls include GPS maneuvering systems and obstacle recognition and avoidance systems, and digital security systems including user face and voice recognition systems.

### BRIEF DESCRIPTION OF THE DRAWINGS

FIG. 1 shows for illustrative purposes only an example of an overview of a method and devices for a smart tripod of one embodiment.

FIG. 2 shows for illustrative purposes only an example of a smart tripod with cameras mounted of one embodiment.

FIG. 3 shows for illustrative purposes only an example of a smart tripod following user signal for a photo of one embodiment.

FIG. 4 shows for illustrative purposes only an example of a user using a smart tripod pendant signaling device of one embodiment.

FIG. 5 shows for illustrative purposes only an example of a pendant signal to a smart tripod of one embodiment.

FIG. 6 shows for illustrative purposes only an example of a smart tripod going up a knoll for a photo of one embodiment.

FIG. 7 shows for illustrative purposes only an example of a smart tripod telescoping supports for an incline of one embodiment.

FIG. 8 shows for illustrative purposes only an example of a smart tripod gimbal leveling stabilizer of one embodiment.

FIG. 9A shows for illustrative purposes only an example of a smart tripod equipment platform in level landscape position of one embodiment.

FIG. 9B shows for illustrative purposes only an example of a smart tripod equipment platform in portrait position of one embodiment.

FIG. 10 shows for illustrative purposes only an example of smart tripod track drive systems of one embodiment.

FIG. 11A shows for illustrative purposes only an example of a rechargeable battery power system of one embodiment.

FIG. 11B shows for illustrative purposes only an example of rechargeable battery power system auxiliary batteries of one embodiment.

FIG. 12A shows for illustrative purposes only an example of a smart tripod computer control system of one embodiment.

FIG. 12B shows for illustrative purposes only an example of smart tripod sensor arrays of one embodiment.

FIG. 13 shows for illustrative purposes only an example of a smart tripod gimbal stabilizer system of one embodiment.

FIG. 14 shows for illustrative purposes only an example of a smart tripod pneumatic wheel drive system of one embodiment.

FIG. 15 shows for illustrative purposes only an example of a self-propelled light-weight smart tripod of one embodiment.

FIG. 16A shows for illustrative purposes only an example of a smart tripod self-propelled luggage apparatus of one embodiment.

FIG. 16B shows for illustrative purposes only an example of a smart tripod self-propelled luggage apparatus elevated telescoping camera mount of one embodiment.

FIG. 16C shows for illustrative purposes only an example of smart tripod self-propelled luggage apparatus fully elevated telescoping tripod supports of one embodiment.

FIG. 17 shows for illustrative purposes only an example of smart tripod self-propelled luggage apparatus fully elevated telescoping tripod supports details of one embodiment.

FIG. 18A shows for illustrative purposes only an example of a smart tripod movable luggage attachment system of one embodiment.

FIG. 18B shows for illustrative purposes only an example of smart tripod movable luggage control modules of one embodiment.

FIG. 19 shows for illustrative purposes only an example of a smart tripod self-propelled luggage apparatus photographing a user in a following condition of one embodiment.

FIG. 20 shows for illustrative purposes only an example of a smart tripod self-propelled luggage apparatus tracking a user signal for photographing while circling a user per user motion signals of one embodiment.

FIG. 21 shows for illustrative purposes only an example of a user setting a smart phone app GPS route for a smart tripod of one embodiment.

FIG. 22 shows for illustrative purposes only an example of a smart tripod self-steering a user smart phone app GPS route with obstacle recognition and avoidance of one embodiment.

FIG. 23 shows for illustrative purposes only an example of a planned GPS path of one embodiment.

FIG. 24 shows for illustrative purposes only an example of a smart tripod self-maneuvering planned GPS path of one embodiment.

FIG. 25 shows for illustrative purposes only an example of a removable personal scooter smart tripod foldable assembly of one embodiment.

FIG. 26 shows for illustrative purposes only an example of a removable personal scooter smart tripod foldable assembly folded for storage of one embodiment.

FIG. 27A shows for illustrative purposes only an example of a smart tripod user location transponder ring of one embodiment.

FIG. 27B shows for illustrative purposes only an example of a smart tripod user location transponder brooch of one embodiment.

FIG. 27C shows for illustrative purposes only an example of a smart tripod user location transponder bracelet of one embodiment.

FIG. 27D shows for illustrative purposes only an example of a smart tripod user location transponder necklace of one embodiment.

FIG. 27E shows for illustrative purposes only an example of a smart tripod user location transponder ballpoint pen of one embodiment.

FIG. 28 shows a block diagram of an overview of a first group of smart tripod features of one embodiment.

FIG. 29 shows a block diagram of an overview of a second group of smart tripod features of one embodiment.

FIG. 30 shows a block diagram of an overview of a third group of smart tripod features of one embodiment.

FIG. 31 shows a block diagram of an overview of a fourth group of smart tripod features of one embodiment.

FIG. 32 shows for illustrative purposes only an example of a movable luggage integrated telescoping smart tripod system of one embodiment.

FIG. 33 shows for illustrative purposes only an example of a movable luggage integrated telescoping smart tripod fully telescoped of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of a method and devices for a smart tripod is described for illustrative purposes and the underlying system can apply to any number and multiple types equipment uses. In one embodiment of the present invention, the method and devices for a smart tripod can be configured using control systems using sensors, optics, digital and electronic devices and mechanical devices. The method and devices for a smart tripod can be configured to include a track drive system and can be configured to include other drive systems including pneumatic wheels using the present invention of one embodiment.

In all embodiments of the present invention the smart tripod is configured to include an auto-drive guidance override transmitter adjustable to the same frequency as the steering control system. This allows the smart tripod user to select an object or person or targeted portions of the object or person for physically tracking the object or person at a user selected distance using the overridden steering system. A user may target a portion of the object or person for physically tracking the object or person for example by using the camera remote controls to capture a photo of the portion of the object or person to be targeted and tracked. The captured photo image may include a distinguishing contour, shape, color, and pattern on the object or person. The smart tripod can be configured with an optical scanner directed at the object or person. The continuous scanned images are compared to the targeted captured photo image using an artificial Intelligence device to determine if the scanned images match the targeted captured photo image using range finders, arc comparative calculations, and proportional size adjustment determined by the angle of view. The artificial Intelligence device may also be used to determine lighting conditions and make automatic adjustments in shutter settings. The artificial Intelligence device may also be used to fit the subject into an optimum photographic frame position with gimbal positioning adjustments of one embodiment.

When a match of the scanned image and targeted captured photo image is made the optical scanner transmits the coordinates of the scanned image to the steering control system to alter the smart tripod position to acquire the targeted image into the field of view of one embodiment.

In all embodiments of the present invention the smart tripod is configured to include mountings for both video cameras and still photo cameras. In instances where a camera has the capability of capturing both video and still photos, a user digital application installed on for example a smart phone with dual video and still photos photographic capacity, a user may use the digital application to switch between the two modes of operation even remotely. In addition in all embodiments of the present invention the smart tripod is configured to include a sound and voice recording device that may be used in coordination with the photographic devices or independently for recording sounds and voices of one embodiment.

In all embodiments of the present invention the smart tripod is configured to include motorized wheels for independent movement apart from being pushed by a user. The independent movement provided with the motorized wheels allows the smart tripod to follow, track and avoid obstacles. Smart tripod sensors and artificial intelligence provide the capability to differentiate people from objects and identify user targeted objects, people and specific areas of those targets. The luggage mounted embodiments of the smart tripod also include motorized wheels to provide independent movement and together with the coupled Smart tripod sensors and artificial intelligence can follow, track and avoid obstacles. Luggage mounted embodiments also include Smart tripod sensors and artificial intelligence provide the capability to differentiate people from objects and identify user targeted objects, people and specific areas of those targets.

In all embodiments of the present invention the smart tripod is configured to include lighting fixtures coupled to the tripod legs, platforms and other surfaces to assist the user in low light and night operations. The lighting fixtures may be battery operated. The lighting fixtures may include magnetic coupling brackets to attach to metallic tripod components to allow a user to place a lighting fixture where they feel they are needed of one embodiment.

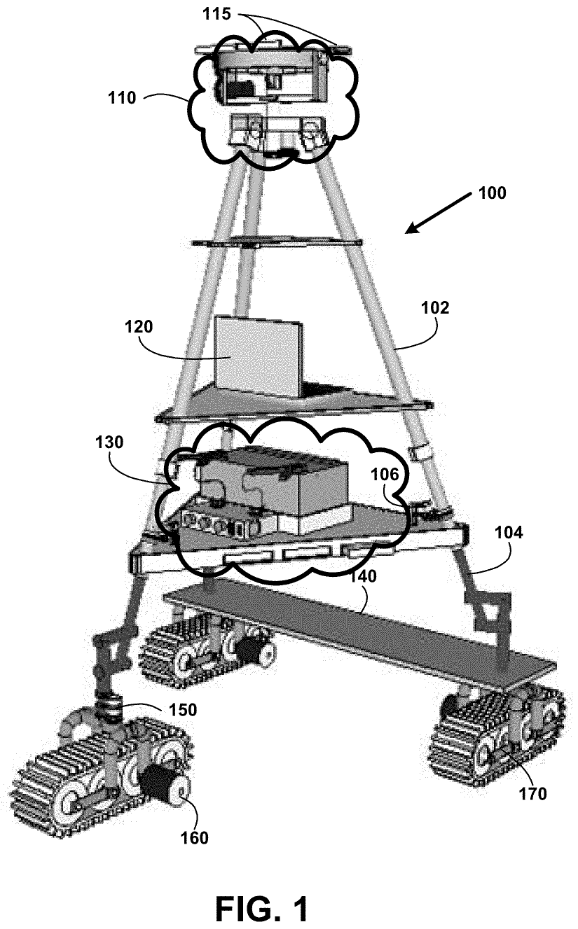

FIG. 1 shows for illustrative purposes only an example of an overview of a method and devices for a smart tripod of one embodiment. FIG. 1 shows one embodiment of a smart tripod in a smart tripod track driven 100. The smart tripod track driven 100 includes a plurality of a smart tripod telescoping leg 102 with a telescoping track support 104. A telescoping device 106 is used to independently extend and retract each smart tripod telescoping leg 102 and telescoping track support 104. A camera platform gimbal leveling device 110 is coupled to a camera mounting platform 115. The camera platform gimbal leveling device 110 is used to maintain a stable orientation of the camera mounting platform 115 to prevent a mounted camera from losing a stable camera view of a photographic subject while the smart tripod track driven 100 is maneuvering for example over uneven surfaces.

A laptop computer with smart tripod application 120 controls the operations of the smart tripod track driven 100 including remote controlling by a user using the smart tripod application installed in a user digital device. A rechargeable battery power system 130 provides power to the laptop computer, camera platform gimbal leveling device 110, a front track steering system 150, each telescoping device 106 and each track drive motor 160 that drives a track drive with articulated suspension 170. A user stand-on platform 140 provides a feature wherein a user may stand on the platform and ride-along while the smart tripod track driven 100 is maneuvering and traveling between photo shots of one embodiment.

### DETAILED DESCRIPTION

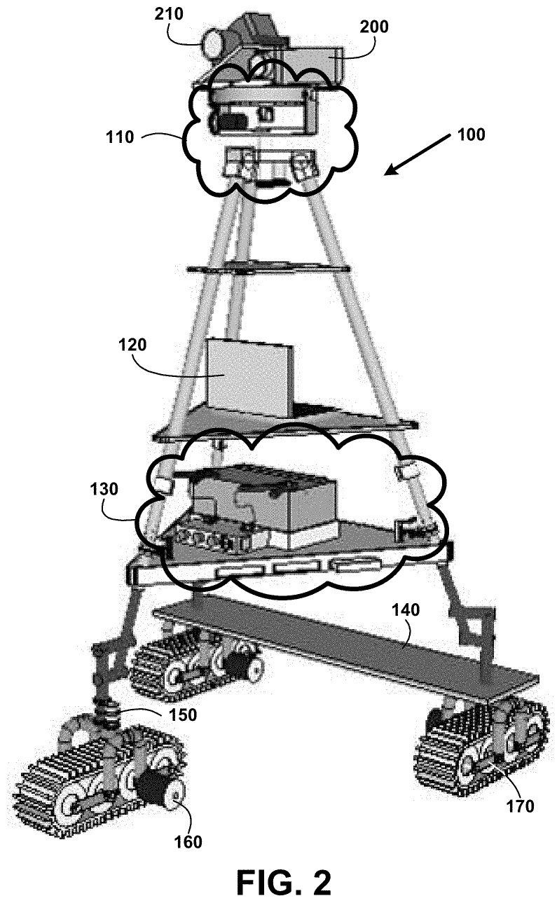

FIG. 2 shows for illustrative purposes only an example of a smart tripod with cameras mounted of one embodiment. FIG. 2 shows the smart tripod track driven 100, camera platform gimbal leveling device 110, camera mounting platform 115, laptop computer with smart tripod application 120, rechargeable battery power system 130, user stand-on platform 140, auto-drive on-board guidance controls including a front track steering system 150, track drive motor 160 and track drive with articulated suspension 170. FIG. 2 also shows a video camera 200 and a still camera 210 mounted on the camera mounting platform 115. The camera platform gimbal leveling device 110 adjusts the level and tilt of the camera mounting platform 115 to keep the video camera 200 and still camera 210 stabilized to prevent the camera images being captured stabilized and prevent jiggling and bouncing while the smart tripod track driven 100 is traveling and maneuvering of one embodiment.

### A Smart Tripod Following User Signal for a Photo:

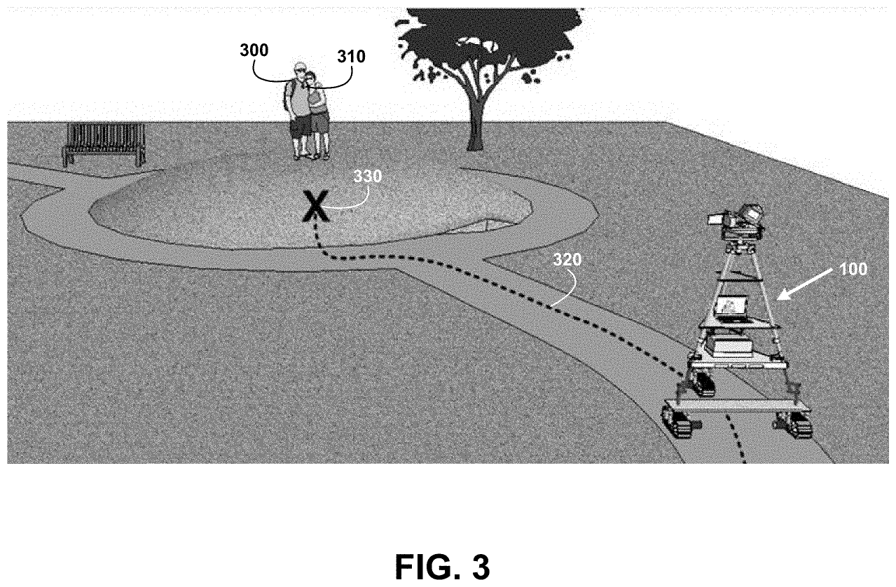

FIG. 3 shows for illustrative purposes only an example of a smart tripod following user signal for a photo of one embodiment. FIG. 3 shows the smart tripod track driven 100 maneuvering along a pathway in a park setting. A user 300 wearing a smart tripod user location transponder 310 is standing on a slight knoll. The smart tripod user location transponder 310 is broadcasting a location signal to the smart tripod track driven 100. The smart tripod track driven 100 includes a sensor for receiving the user location signal. The smart tripod track driven 100 also includes auto-drive on-board guidance controls including a sensor for evaluating the terrain in front of the smart tripod track driven 100 paths. The sensor evaluation determines the smoother paved path and calculates a route to remain on the smoother sensor detected pathway 320 ahead. The directions to remain on the smoother paved path are transmitted to the front track steering system 150 of FIG. 1. The smart tripod user location transponder 310 broadcasted location signal leads the smart tripod track driven 100 unit to a user selected smart tripod camera view location 330 of one embodiment.

### A User Using a Smart Tripod Pendant Signaling Device:

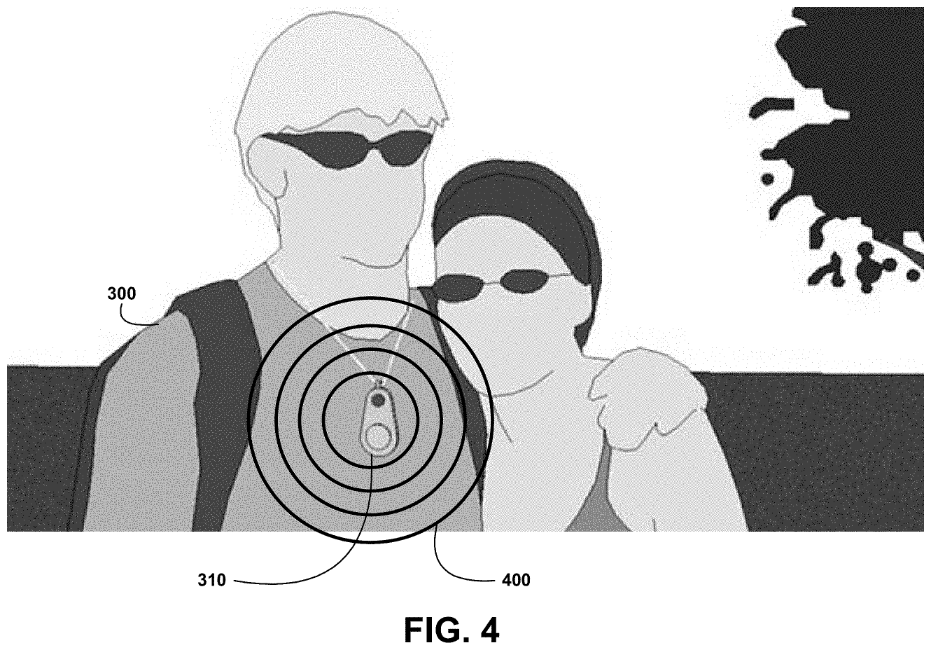

FIG. 4 shows for illustrative purposes only an example of a user using a smart tripod pendant signaling device of one embodiment. FIG. 4 shows a user 300 wearing a smart tripod user location transponder 310 configured in a pendant. A signaling pendant transmitting a user location signal 400 is used to guide in this example the smart tripod track driven 100 of FIG. 1 unit to the location of the user of one embodiment.

### A Pendant Signal to a Smart Tripod:

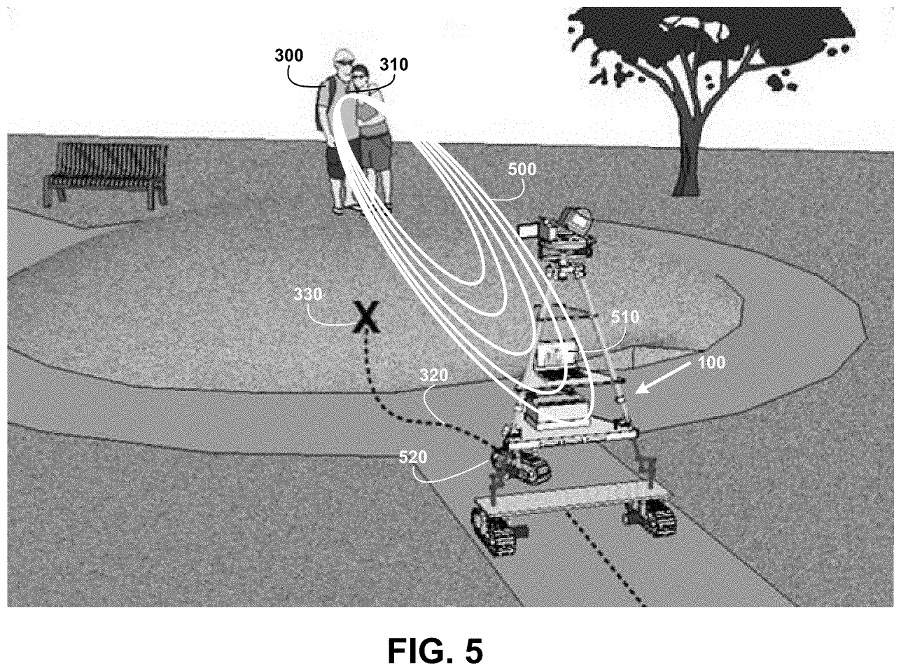

FIG. 5 shows for illustrative purposes only an example of a pendant signal to a smart tripod of one embodiment. FIG. 5 shows the smart tripod track driven 100 unit receiving the user 300 smart tripod user location transponder 310 signal and following a sensor detected pathway 320 to the user selected smart tripod camera view location 330. A location signal broadcast 500 may cover a predetermined omnidirectional distance. The location signal broadcast 500 provides a location signal received by auto-drive on-board guidance controls including a user smart tripod laptop computer with a smart tripod application installed 510 to calculate a direction transmission to a front track steering apparatus for turning the smart tripod 520 to change directions to reach the user selected smart tripod camera view location 330 of FIG. 3 of one embodiment.

### A Smart Tripod Going Up a Knoll for a Photo:

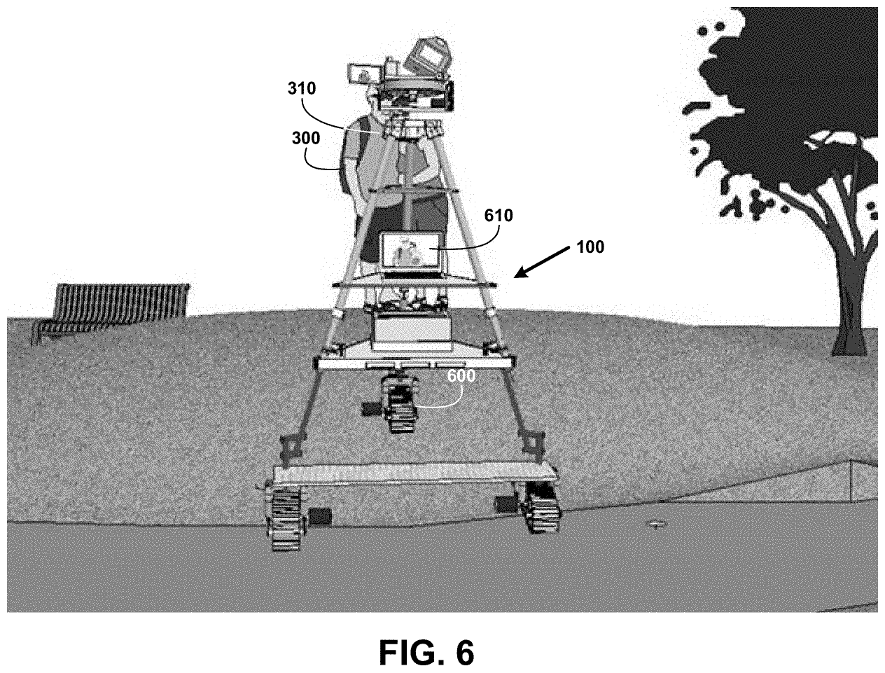

FIG. 6 shows for illustrative purposes only an example of a smart tripod going up a knoll for a photo of one embodiment. FIG. 6 shows the smart tripod track driven 100 unit maneuvering up a knoll and stopping at the user selected smart tripod camera view location 600. The user 300 and smart tripod user location transponder 310 are seen in a transmitted camera image received by the smart tripod application and displayed on the user laptop computer 610 of one embodiment.

### A Smart Tripod Telescoping Supports for an Incline:

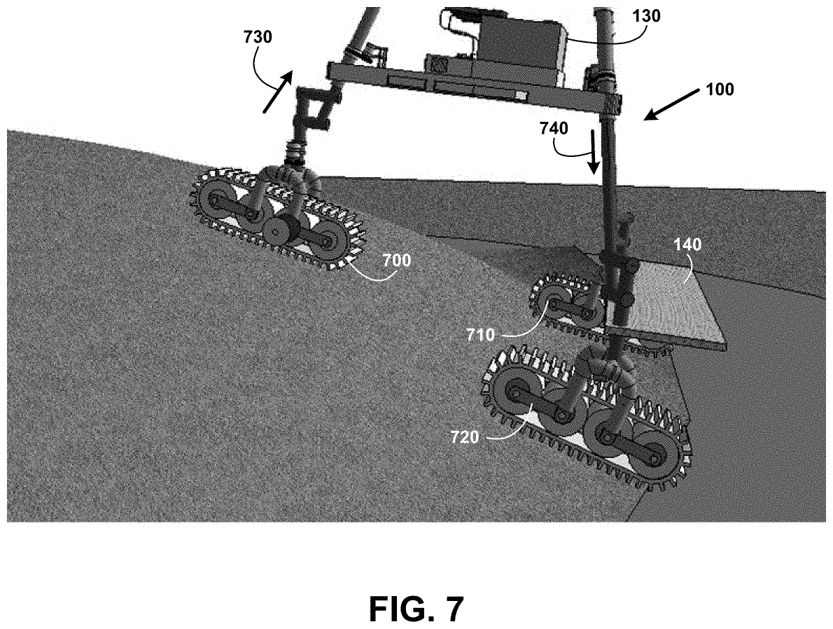

FIG. 7 shows for illustrative purposes only an example of a smart tripod telescoping supports for an incline of one embodiment. FIG. 7 shows the smart tripod track driven 100 unit stopping at the user selected smart tripod camera view location. Also seen are the rechargeable battery power system 130, user stand-on platform 140, a front track 700, a right back track 710 and a left back track 720. To maintain overall stability of the smart tripod leveling sensors adjust tripod leg sections length. For example in this position a front track telescoping support is shortened 730 and a left back track telescoping support is lengthened 740 to adjust for the incline of the knoll of one embodiment.

### A Smart Tripod Gimbal Leveling Stabilizer:

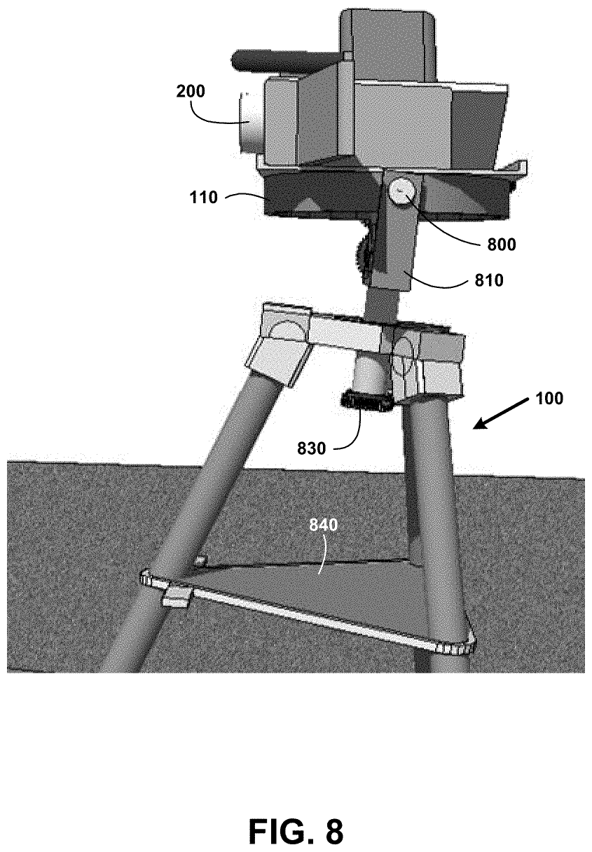

FIG. 8 shows for illustrative purposes only an example of a smart tripod gimbal leveling stabilizer of one embodiment. FIG. 8 shows the smart tripod track driven 100 unit and camera platform gimbal leveling device 110. The video camera 200 is this example is tilted using a gimbal axis 800 coupled to to gimbal frame 810. Gimbal movements are made using a gimbal rotating motor and gear box 830 activated by leveling sensor signals. Also shown is a removable platform 840 snapped on between tripod legs of one embodiment.

### A Smart Tripod Equipment Platform in Level Landscape Position:

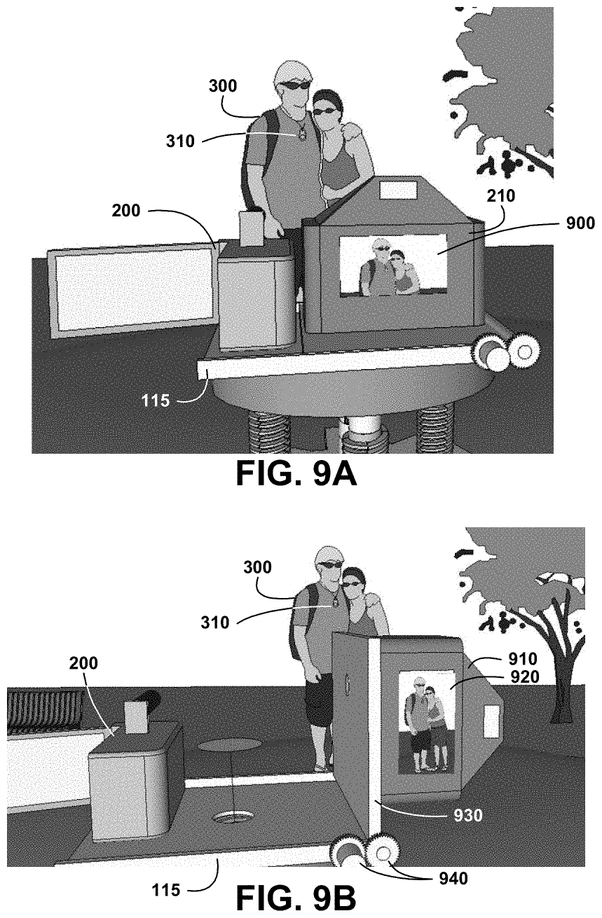

FIG. 9A shows for illustrative purposes only an example of a smart tripod equipment platform in level landscape position of one embodiment. FIG. 9A shows the video camera 200 and still camera 210 coupled to the camera mounting platform 115. In the background is the user 300 wearing the smart tripod user location transponder 310. The still camera 210 shows a stabilized camera image of user couple 900 in a landscape format of one embodiment.

### A Smart Tripod Equipment Platform in Portrait Position:

FIG. 9B shows for illustrative purposes only an example of a smart tripod equipment platform in portrait position of one embodiment. FIG. 9B shows the video camera 200 and camera mounting platform 115. In the background is the user 300 wearing the smart tripod user location transponder 310. User selected command signals were used wherein the user has signaled the still camera to transition into portrait position using the smart tripod application installed on a user digital device not shown and in this example a user smart phone. The user transmitted the camera mounting platform 115 to place a still camera platform tilted into portrait mode 930.

The still camera platform position is adjusted using a camera platform tilt motor and gears 940 to tilt 90 degrees for a still camera in portrait position 910. User selected command signals include the user using the smart tripod application installed on the user smart phone to take a photo on a time delay allowing the user to put the smart phone in his pocket and for the couple to pose for the photo of the user couple image in portrait camera frame 920 of one embodiment.

### Smart Tripod Track Drive Systems:

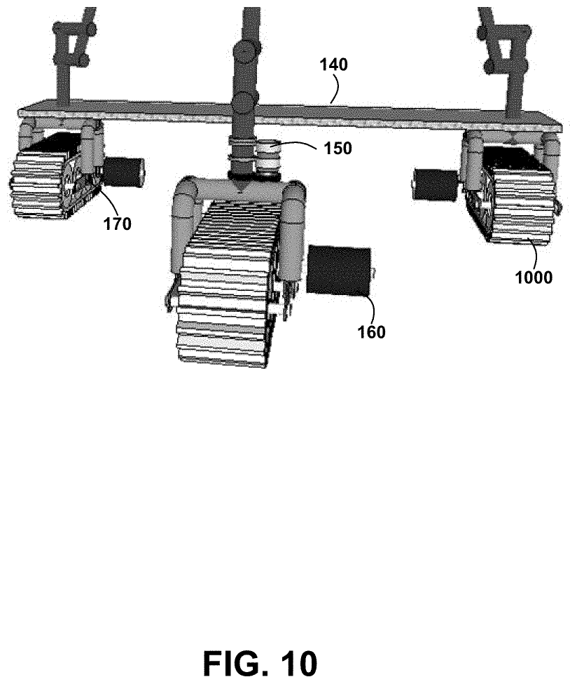

FIG. 10 shows for illustrative purposes only an example of smart tripod track drive systems of one embodiment. FIG. 10 shows the user stand-on platform 140, front track steering system 150, track drive motor 160, track drive with articulated suspension 170 and track treads 1000 of one embodiment.

### A Rechargeable Battery Power System:

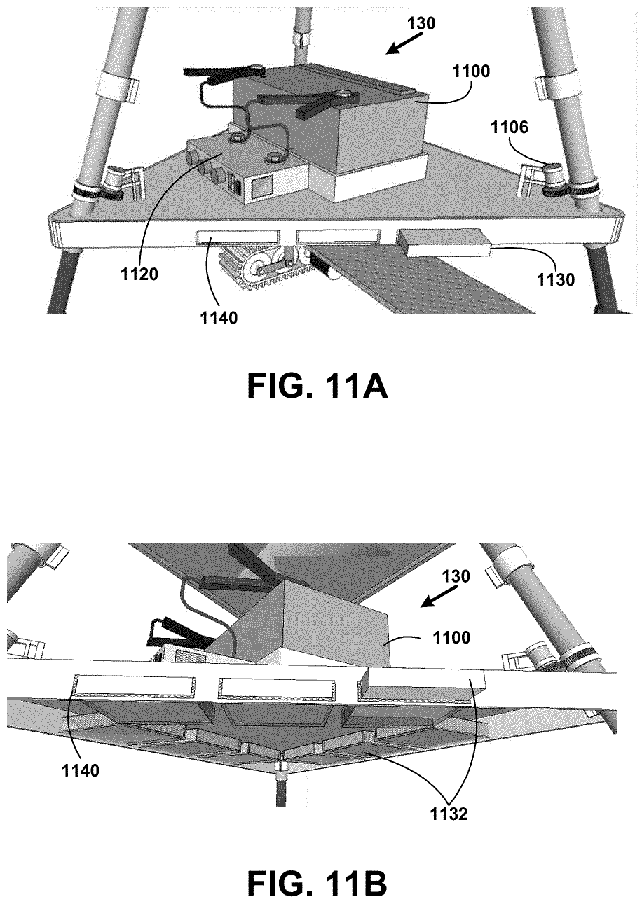

FIG. 11A shows for illustrative purposes only an example of a rechargeable battery power system of one embodiment. FIG. 11A shows a close up of the rechargeable battery power system 130, telescoping motor and gear device 1106, rechargeable battery 1100, rechargeable battery power system auxiliary battery 1130, power distributor control device 1120, and rechargeable battery power auxiliary battery connection compartment 1140. The power distributor control device 1120 controls the amount of power being distributed to the electrical and electronic devices coupled to the smart tripod track driven 100 of FIG. 1 unit. For example the amount of power and time duration of power transmitted to each track drive motor 160 of FIG. 1 adjusts the speed and distance traveled by each track for example while turning, circling, and up and down hill speeds of one embodiment.

### Rechargeable Battery Power System Auxiliary Batteries:

FIG. 11B shows for illustrative purposes only an example of rechargeable battery power system auxiliary batteries of one embodiment. FIG. 11B shows the rechargeable battery power system 130, rechargeable battery 1100, rechargeable lithium battery 1132, and rechargeable battery power auxiliary battery connection compartment 1140 of one embodiment.

### A Smart Tripod Computer Control System:

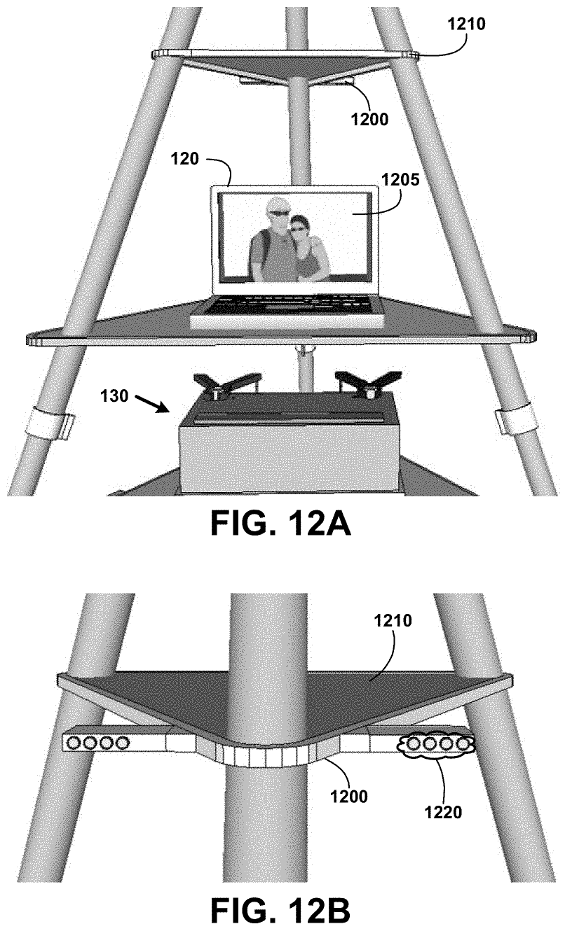

FIG. 12A shows for illustrative purposes only an example of a smart tripod computer control system of one embodiment. FIG. 12A shows the laptop computer with smart tripod application 120, rechargeable battery power system 130 and a captured image display on laptop computer 1205. Also showing are a sensor array support mounting bracket 1200 and sensor array support mounting bracket and platform 1210 of one embodiment.

### Smart Tripod Sensor Arrays:

FIG. 12B shows for illustrative purposes only an example of smart tripod sensor arrays of one embodiment. FIG. 12B shows the sensor array support mounting bracket 1200 and sensor array support mounting bracket and platform 1210. A sensor array 1220 includes sensors for photographic light levels, the path ahead of the smart tripod, visible light and infrared light obstacle detection, and other sensors forming auto-drive on-board guidance controls used for operating the smart tripod of one embodiment.

### Smart Tripod Gimbal Stabilizer System:

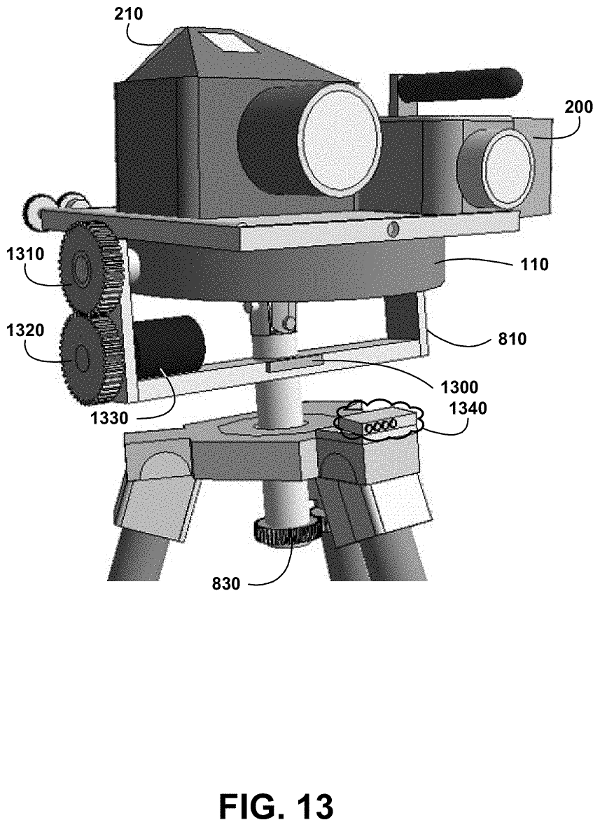

FIG. 13 shows for illustrative purposes only an example of smart tripod gimbal stabilizer system of one embodiment. FIG. 13 shows the gimbal frame 810 and gimbal rotating motor and gear box 830 of the camera platform gimbal leveling device 110. The camera mounting platform 115 of FIG. 1 has a coupled video camera 200 and still camera 210. The gimbal frame 810 includes a camera view stabilizer sensor bar 1300 for activating a gimbal tilt gear 1310; gimbal transfer gear 1320 and a gimbal tilt motor 1330. The camera view stabilizer sensor bar 1300 includes a light level sensor, focus distance range finder, photographic framing and subject targeting sensor array 1340 of one embodiment.

### Smart Tripod Pneumatic Wheel Drive System:

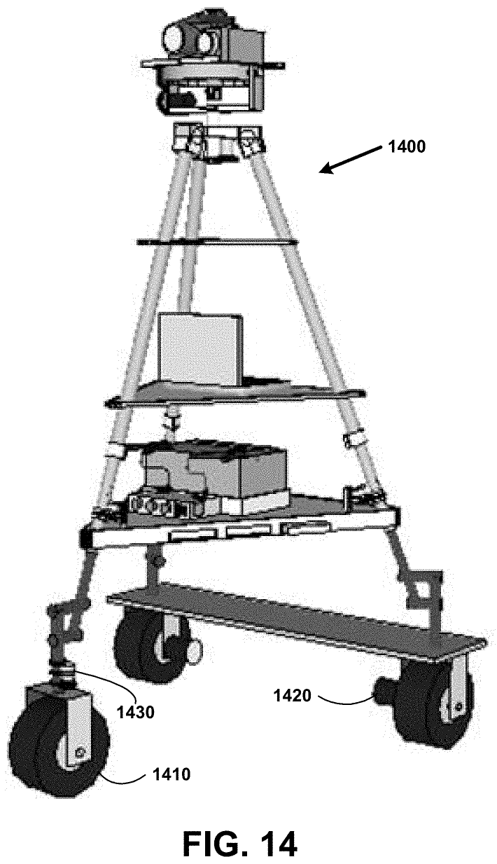

FIG. 14 shows for illustrative purposes only an example of smart tripod pneumatic wheel drive system of one embodiment. FIG. 14 shows a smart tripod pneumatic wheel drive system 1400 that includes at least three pneumatic tire 1410 units, pneumatic wheel drive motor 1420 and one front pneumatic wheel steering apparatus 1430. The smart tripod pneumatic wheel drive system 1400 may be used on surfaces that may be damaged by tracks and are more consistently level versus hilly natural terrain with uneven surfaces. The smart tripod may be fitted with the removable and interchangeable track drive system or pneumatic wheel drive system of one embodiment.

### A Self-Propelled Light-Weight Smart Tripod:

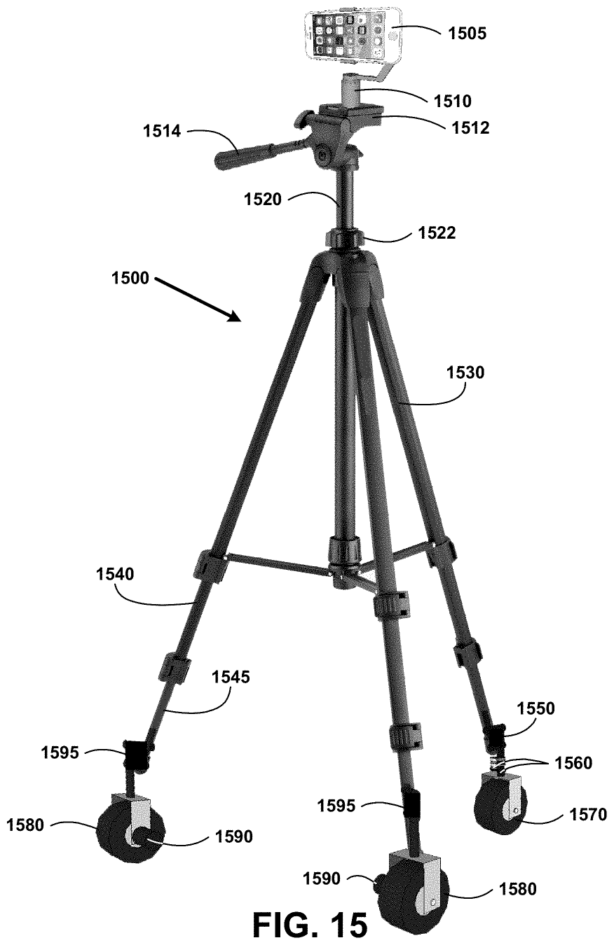

FIG. 15 shows for illustrative purposes only an example of a self-propelled light-weight smart tripod of one embodiment. FIG. 15 shows a smart tripod light weight small wheel driven 1500 unit with auto-drive on-board guidance controls. The smart tripod light weight small wheel driven 1500 unit supports a smart phone with camera 1505. The smart phone with camera 1505 is mounted on a gimbal camera stabilizer 1510. The gimbal camera stabilizer 1510 is coupled to a gimbal mounting platform with sensor array 1512 with a tilt locking screw 1514.

The gimbal mounting platform with sensor array 1512 is coupled to a telescoping vertical post 1520 with a telescoping post locking device 1522 to hold the selected telescoped position. Three telescoping leg 1530 include lower telescoping legs 1540 and include telescoping small wheel support 1545 devices. On-board guidance controls include a front small wheel steering device 1550 is used to steer the smart tripod light weight small wheel driven 1500 unit in a preplanned, determined or obstacle avoidance direction. The telescoping small wheel support 1545 devices may include at least one rechargeable battery, a wireless digital controller, a GPS steering controller and steering device 1560 and a front small wheel 1570. Each back small wheel 1580 includes a small wheel drive motor 1590 and a rechargeable battery, and wireless digital controller 1595 of one embodiment.

### Smart Tripod Self-Propelled Luggage Apparatus:

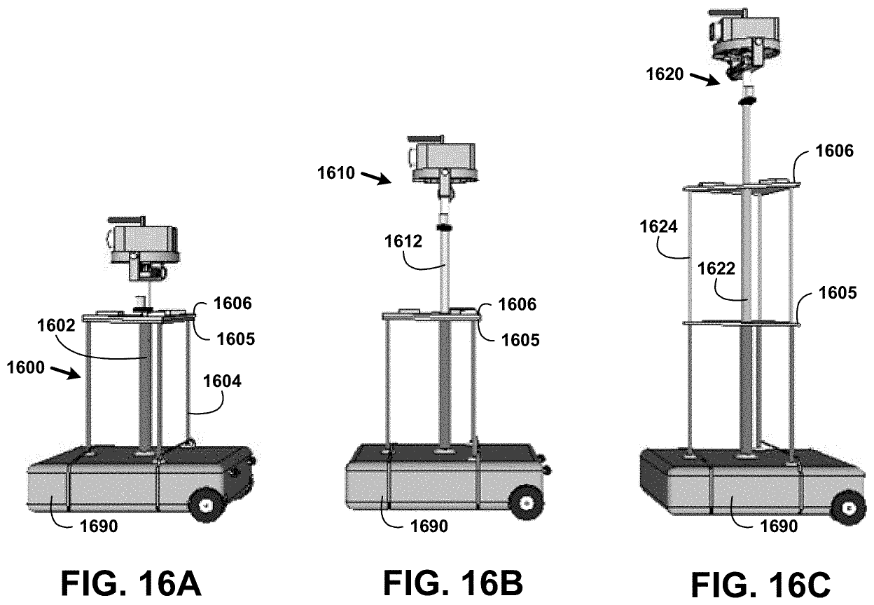

FIG. 16A shows for illustrative purposes only an example of smart tripod self-propelled luggage apparatus of one embodiment. FIG. 16A shows a removable smart tripod self-propelled luggage apparatus 1600. The removable smart tripod self-propelled luggage apparatus 1600 includes a telescoping gimbal and camera platform support post 1602 and a telescoping platform tripod support 1604 removably attached to a self-propelled luggage apparatus 1690. The removable smart tripod self-propelled luggage apparatus 1600 also includes two tiered support platforms. The lower platform is a triangular rigid platform 1605 to secure vertical positions of the three telescoping platform tripod support 1604 elements. The upper platform 1606 is a triangular rigid platform to secure the vertical spacing of the three telescoping platform tripod support 1604 terminuses and a mounting platform for the removable smart tripod self-propelled luggage apparatus 1600 battery and operational controls of one embodiment.

### Smart Tripod Self-Propelled Luggage Apparatus Elevated Telescoping Camera Mount:

FIG. 16B shows for illustrative purposes only an example of smart tripod self-propelled luggage apparatus elevated telescoping camera mount of one embodiment. FIG. 16B shows a removable smart tripod self-propelled luggage apparatus elevated telescoping camera mount 1610 in a telescoping gimbal and camera platform support post first elevated telescoped position 1612 attached to the self-propelled luggage apparatus 1690. The lower platform holds the three telescoping platform tripod support 1604 of FIG. 16A elements in their vertical position to maintain the telescoping gimbal and camera platform support post first elevated telescoped position 1612 in a stable vertical position of one embodiment.

### Smart Tripod Self-Propelled Luggage Apparatus Fully Elevated Telescoping Tripod Supports:

FIG. 16C shows for illustrative purposes only an example of smart tripod self-propelled luggage apparatus fully elevated telescoping tripod supports of one embodiment. FIG. 16C shows a removable smart tripod self-propelled luggage apparatus elevated telescoping camera mount and fully elevated telescoping tripod supports 1620. Three fully extended telescoping tripod platform support 1624 elements raise the upper platform to its fully extended position 1630. A telescoping gimbal and camera platform support post second elevated telescoped position 1622 raises the camera platform gimbal leveling device 110 of FIG. 1 and the camera mounting platform 115 of FIG. 1 to a fully extended position on the self-propelled luggage apparatus 1690 of one embodiment.

### Smart Tripod Self-Propelled Luggage Apparatus Fully Elevated Telescoping Tripod Supports Details:

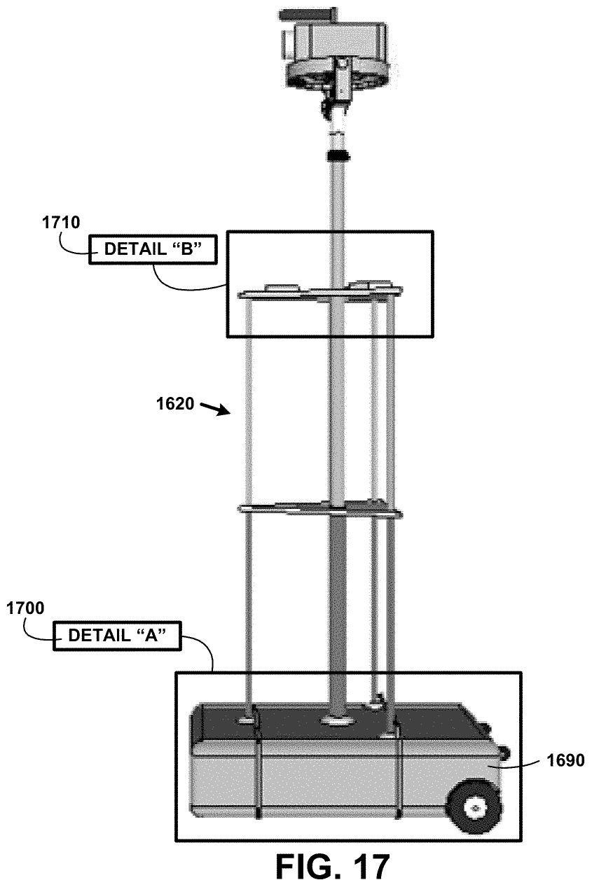

FIG. 17 shows for illustrative purposes only an example of smart tripod self-propelled luggage apparatus fully elevated telescoping tripod supports details of one embodiment. FIG. 17 shows the removable smart tripod self-propelled luggage apparatus elevated telescoping camera mount and fully elevated telescoping tripod supports 1620. FIG. 17 also shows a detail “A” 1700 and a detail “B” 1710 of the removable smart tripod self-propelled luggage apparatus elevated telescoping camera mount and fully elevated telescoping tripod supports 1620 coupled to the self-propelled luggage apparatus 1690 of one embodiment.

### Smart Tripod Movable Luggage Attachment System:

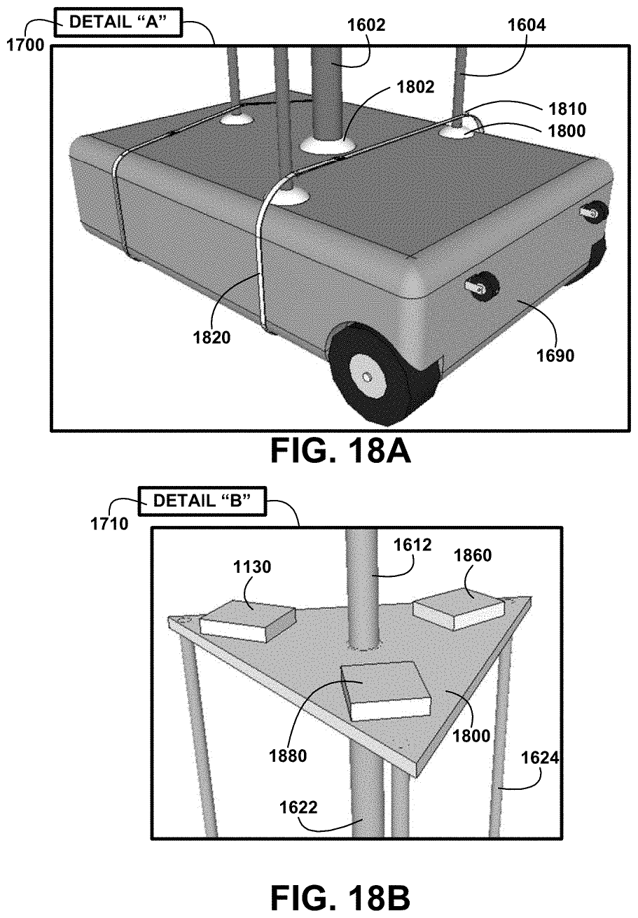

FIG. 18A shows for illustrative purposes only an example of smart tripod movable luggage attachment system of one embodiment. FIG. 18A shows detail “A” 1700 showing a removable attachment adjustable strap 1820 for attaching the removable smart tripod self-propelled luggage apparatus 1600 of FIG. 16A to the self-propelled luggage apparatus 1690. The removable attachment adjustable strap 1820 is fed through a removable attachment adjustable strap bracket 1810 coupled to the telescoping platform tripod support 1604. The removable attachment adjustable strap 1820 is tightened around the self-propelled luggage apparatus 1690 to secure the position of each telescoping platform tripod support suction cup 1800 and telescoping gimbal and camera platform support post suction cup 1802 holding the telescoping gimbal and camera platform support post 1602 of one embodiment.

### Smart Tripod Movable Luggage Control Modules:

FIG. 18B shows for illustrative purposes only an example of smart tripod movable luggage control modules of one embodiment. FIG. 18B shows detail “B” 1710 showing the fully extended telescoping tripod platform support 1624 and telescoping gimbal and camera platform support post second elevated telescoped position 1622. The telescoping gimbal and camera platform support post first elevated telescoped position 1612 is shown protruding through the equipment and support platform 1800. Mounted on the equipment and support platform 1800 is a GPS and electronics device 1860, a rechargeable lithium battery 1130 and sensors and digital control processor and memory device 1880 of one embodiment.

### Smart Tripod Self-Propelled Luggage Apparatus Photographing a User in a Following Condition:

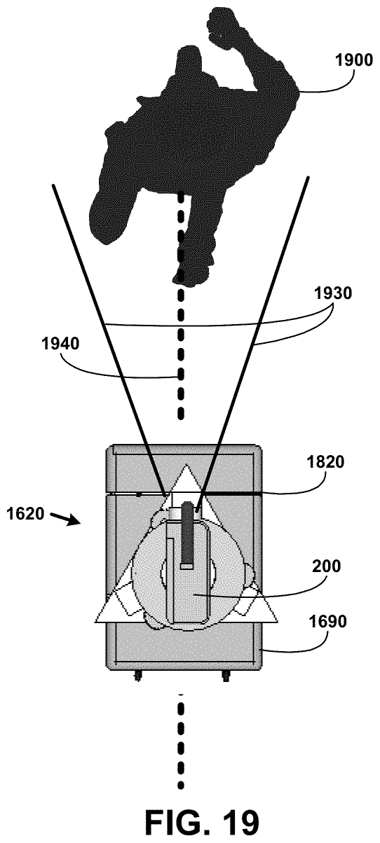

FIG. 19 shows for illustrative purposes only an example of smart tripod self-propelled luggage apparatus photographing a user in a following condition of one embodiment. FIG. 19 shows a user walking in front of the removable smart tripod self-propelled luggage apparatus 1900. Showing are the removable attachment adjustable strap 1820, removable smart tripod self-propelled luggage apparatus elevated telescoping camera mount and fully elevated telescoping tripod supports 1620, the video camera 200 and a video camera image frame view 1930. Seen is the smart tripod path for following user from behind 1940 traveling on the self-propelled luggage apparatus 1690 of one embodiment.

Smart Tripod Self-Propelled Luggage Apparatus Tracking a User Signal for Photographing while Circling a User Per User Motion Signals:

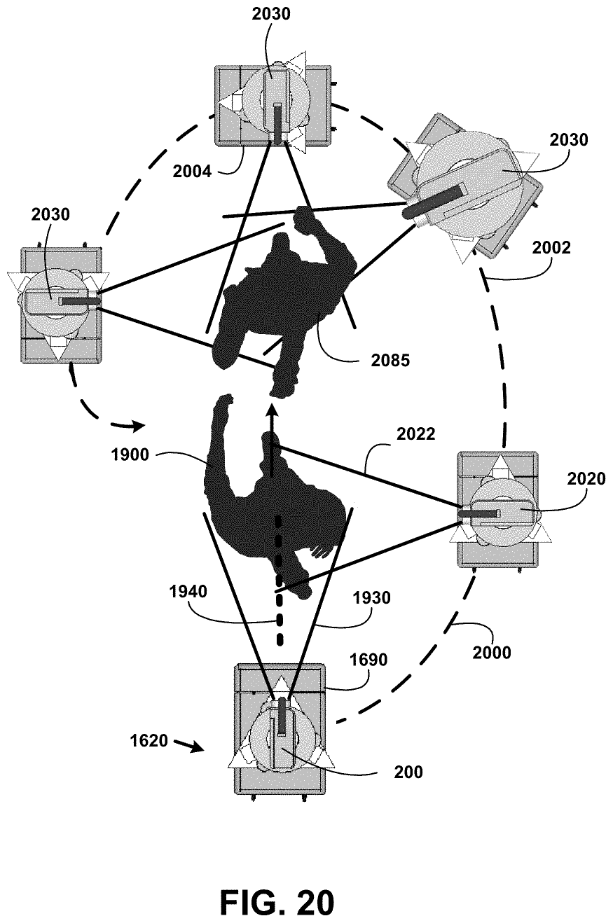

FIG. 20 shows for illustrative purposes only an example of smart tripod self-propelled luggage apparatus tracking a user signal for photographing while circling a user per user motion signals of one embodiment. FIG. 20 shows the user walking in front of the removable smart tripod self-propelled luggage apparatus 1900. The removable smart tripod self-propelled luggage apparatus elevated telescoping camera mount and fully elevated telescoping tripod supports 1620 travels the smart tripod path for following user from behind 1940 the self-propelled luggage apparatus 1690.

The video camera 200 is filming the user within the video camera front image frame view 1930. A user gestures for self-propelled luggage apparatus to circle user while walking. When the user continues walking 2085 a smart tripod tracks the user location transponder during a new circling path 2000. A video camera rotates to the left towards the user 2020 and continues filming in a video camera left side image frame view 2022. A smart tripod continuously tracks user during circular path 2002. A smart tripod continuously tracks the location transponder with video camera during the circling path 2030 of one embodiment.

### A User Setting a Smart Phone App GPS Route for a Smart Tripod:

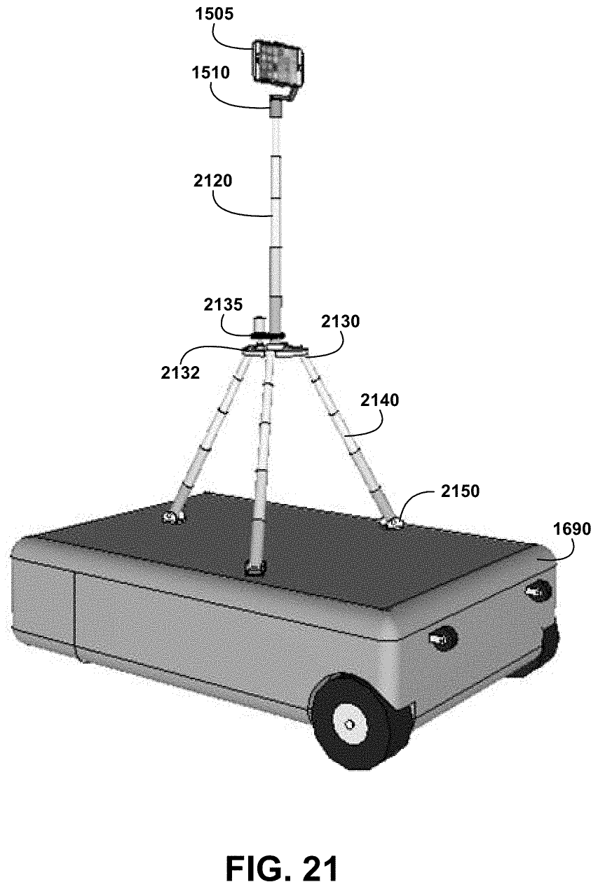

FIG. 21 shows for illustrative purposes only an example of a user setting a smart phone app GPS route for a smart tripod of one embodiment. FIG. 21 shows the self-propelled luggage apparatus 1690 with a group of a telescoping leg luggage fixed hinge connector 2150 connected to a telescoping leg 2140. Each telescoping leg 2140 is coupled to telescoping post mounting platform & telescoping legs hinge points 2130 of a mounting platform 2132. A post rotation motor and gear device 2135 is removably fixed to the mounting platform 2132 with a removable rechargeable lithium battery not shown. The post rotation motor and gear device 2135 is used to rotate a telescoping camera post 2120. The gimbal camera stabilizer 1510 has the smart phone with camera 1505 coupled to it of one embodiment.

Smart Tripod Self-Steering a User Smart Phone App GPS Route with Obstacle Recognition and Avoidance:

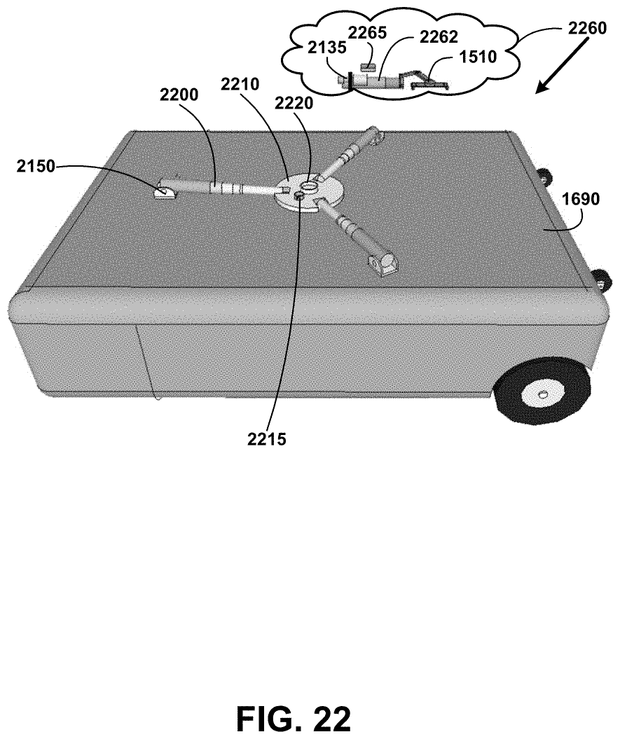

FIG. 22 shows for illustrative purposes only an example of smart tripod self-steering a user smart phone app GPS route with obstacle recognition and avoidance of one embodiment. FIG. 22 shows the self-propelled luggage apparatus 1690 with each telescoping leg retracted 2200 and a post mounting platform lowered against the luggage surface 2210. Also showing is a telescoping post mounting bracket 2220 on the post mounting platform and a post rotation motor and gear device mounting bracket 2215. The retracted telescoping legs are folded against the luggage surface using the telescoping leg luggage fixed hinge connector 2150. Detached from the post mounting platform is the post rotation motor and gear device 2135, rechargeable lithium battery 2265, telescoping camera post retracted 2262, and gimbal camera stabilizer 1510 with the smart phone with camera 1505 of FIG. 21 removed. The detached group of components may be stored inside the luggage compartment 2260 of one embodiment.

### Planned GPS Path:

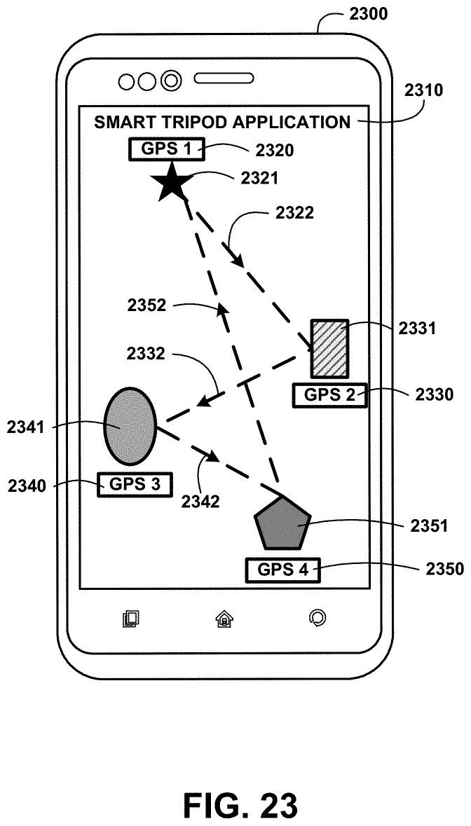

FIG. 23 shows for illustrative purposes only an example of planned GPS path of one embodiment. FIG. 23 shows a user smart phone 2300 with a smart tripod application 2310 installed. The smart tripod application 2310 is used by the user to create a series of user selected command signals to plan a travel path for the smart tripod using the on-board guidance controls. The travel path begins with a GPS 1 2320 starting point 2321 and a first path leg 2322. The first path leg 2322 leads to a GPS 2 2330 point and a first targeted structure 2331. A second path leg 2332 turns towards a GPS 3 2340 point and a second targeted structure 2341. A third path leg 2342 turns towards a GPS 4 2350 point and a third targeted structure 2351 then turns to a fourth path leg returning to starting point 2352 of one embodiment.

### Smart Tripod Self-Maneuvering Planned GPS Path:

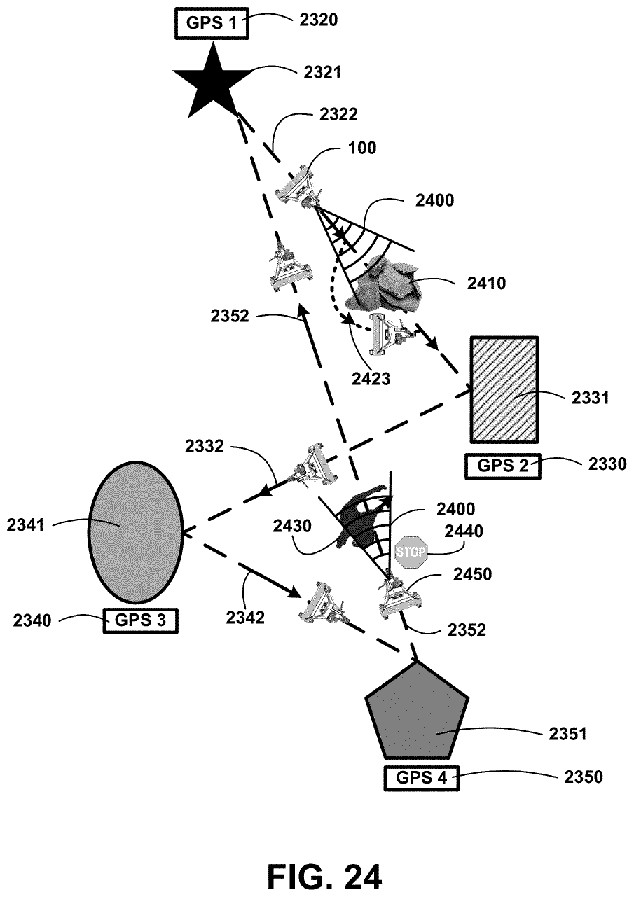

FIG. 24 shows for illustrative purposes only an example of smart tripod self-maneuvering planned GPS path of one embodiment. FIG. 24 shows the smart tripod track driven 100 after leaving the GPS 1 2320 starting point 2321. Along the first path leg 2322 the smart tripod track driven 100 a visual sensor scan area 2400 detects a pile of rocks 2410 in the first path leg 2322. The self-steering user smart phone app GPS route with obstacle recognition and avoidance determination capability determines a smart tripod self-maneuvering path adjustment around the obstacle 2423. The smart tripod track driven 100 reaches the GPS 2 2330 point and first targeted structure 2331 then turns onto the second path leg 2332. The smart tripod track driven 100 reaches the GPS 3 2340 point and the second targeted structure 2341, turns and continues to travel along the third path leg 2342. The smart tripod track driven 100 reaches the GPS 4 2350 point and the third targeted structure 2351.

After turning onto the fourth path leg returning to starting point 2352 the auto-drive on-board guidance controls including a visual sensor scan area 2400 detects a person crossing the smart tripod path 2430. The visual sensor scan area 2400 detects a stop sign for a pedestrian crossing 2440. The visual sensor automatically searches using the smart phone app and recognizes the stop sign symbol and follows the recorded actions associated with the recognized sign 2450. A motion detection sensor also detects a person crossing the path and initiates an auto stop signal to the drive motors. Once the motion detector sensor does not register any motion the smart tripod restarts maneuvering on the fourth path leg returning to starting point 2352 of one embodiment.

### Removable Personal Scooter Smart Tripod Foldable Assembly:

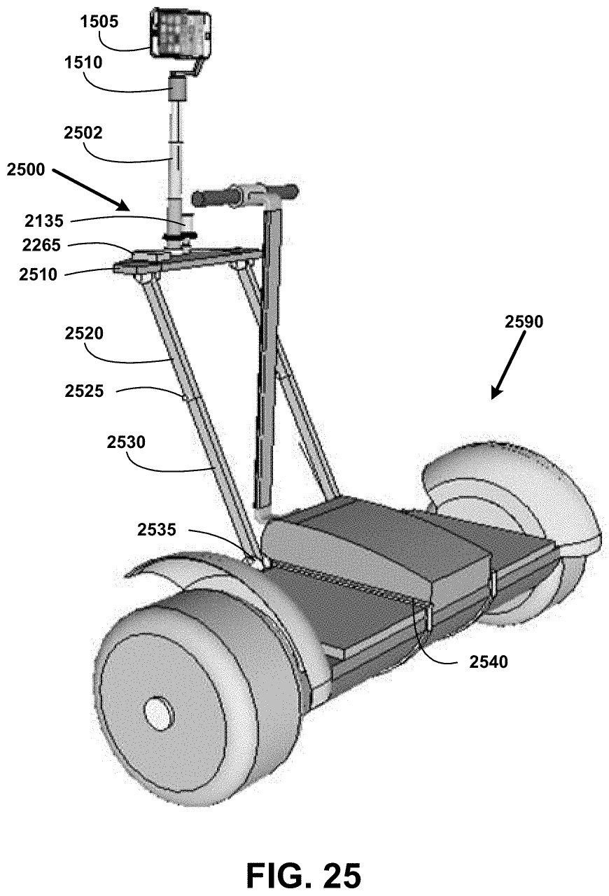

FIG. 25 shows for illustrative purposes only an example of removable personal scooter smart tripod foldable assembly of one embodiment. FIG. 25 shows a personal scooter vehicle 2590 with a removable personal scooter smart tripod foldable assembly 2500 attached. The personal scooter vehicle 2590 with a removable personal scooter smart tripod foldable assembly 2500 at least two adjustable attachment strap 2540. The adjustable attachment strap 2540 is passed through an attachment bracket hinge 2535 of a folding support leg 2530. A support leg locking pin 2525 couples the folding support leg 2530 to an upper folding support leg 2520. The upper folding support leg 2520 is coupled to a folding camera support platform 2510. A telescoping camera post 2502 is a mounting for the gimbal camera stabilizer 1510 with the smart phone with camera 1505. The rechargeable lithium battery 2265 is removably coupled to the folding camera support platform 2510. The post rotation motor and gear device 2135 is also removably coupled to the folding camera support platform 2510 and operated with power from the rechargeable lithium battery 2265 of one embodiment.

### Removable Personal Scooter Smart Tripod Foldable Assembly Folded for Storage:

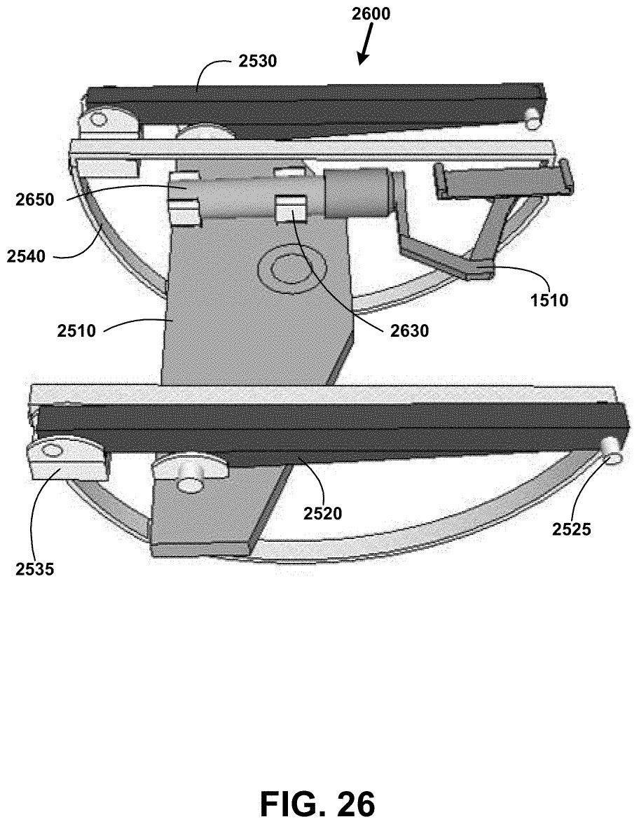

FIG. 26 shows for illustrative purposes only an example of removable personal scooter smart tripod foldable assembly folded for storage of one embodiment. FIG. 26 shows a removable personal scooter smart tripod foldable assembly folded for storage 2600. Each adjustable attachment strap 2540 has been released from the personal scooter vehicle 2590 of FIG. 25. The attachment bracket hinge 2535 and support leg locking pin 2525 provide the means for folding the folding support leg 2530 and upper folding support leg 2520. The folding camera support platform 2510 is folded against the support legs. A telescoping camera post retracted 2650 with the gimbal camera stabilizer 1510 is attached to a set of a retracted telescoping camera post storage clip 2630 and the folded assembly is ready for storage of one embodiment.

### Smart Tripod User Location Transponder Ring:

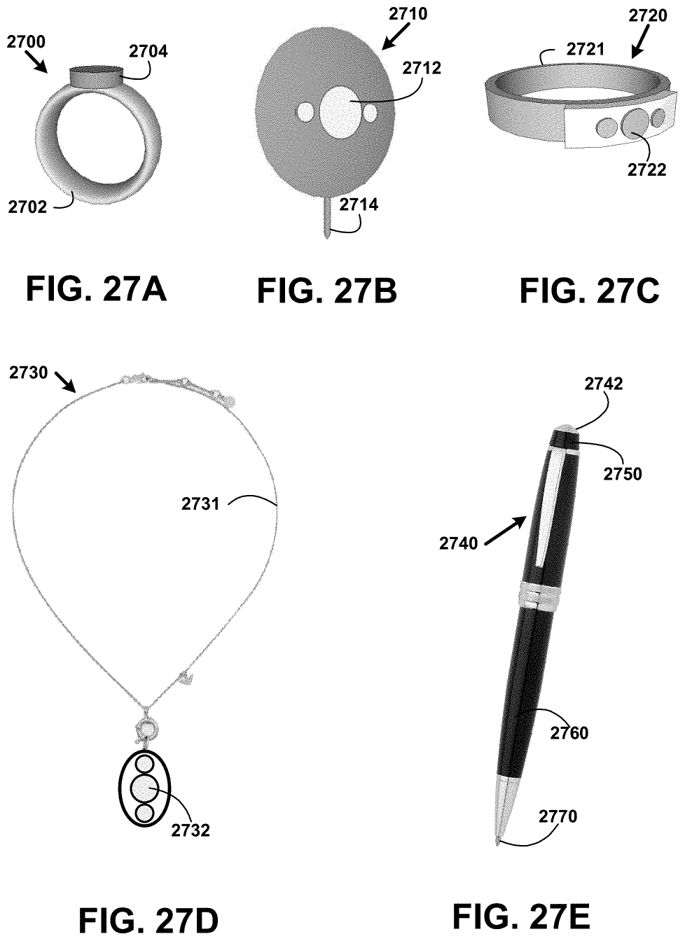

FIG. 27A shows for illustrative purposes only an example of smart tripod user location transponder ring of one embodiment. FIG. 27A shows a smart tripod user location transponder ring 2700. The smart tripod user location transponder ring 2700 includes a ring 2702 with a coupled ring transponder 2704. The ring may come in an adjustable size adaption band feature and a fitted size that a user may order by their ring size of one embodiment.

### Smart Tripod User Location Transponder Brooch:

FIG. 27B shows for illustrative purposes only an example of smart tripod user location transponder brooch of one embodiment. FIG. 27B shows a smart tripod user location transponder brooch 2710. The smart tripod user location transponder brooch 2710 includes a brooch transponder 2712 and a pin 2714 for attaching to clothing or a bag of one embodiment.

### Smart Tripod User Location Transponder Bracelet:

FIG. 27C shows for illustrative purposes only an example of smart tripod user location transponder bracelet of one embodiment. FIG. 27C shows a smart tripod user location transponder bracelet 2720. The smart tripod user location transponder bracelet 2720 includes a wrist bracelet 2721 and a coupled bracelet transponder 2722 with batteries of one embodiment.

### Smart Tripod User Location Transponder Necklace:

FIG. 27D shows for illustrative purposes only an example of smart tripod user location transponder necklace of one embodiment. FIG. 27D shows a smart tripod user location transponder necklace 2730. The smart tripod user location transponder necklace 2730 includes a necklace chain 2731 and a necklace transponder 2732 that is hung on the necklace chain 2731 of one embodiment.

### Smart Tripod User Location Transponder Ballpoint Pen:

FIG. 27E shows for illustrative purposes only an example of a smart tripod user location transponder ballpoint pen of one embodiment. FIG. 27E shows a smart tripod user location transponder ballpoint pen 2740. The smart tripod user location transponder ballpoint pen 2740 includes a ballpoint pen transponder 2742, ballpoint pen transponder battery inside 2750, an ink chamber 2760 and a ball point 2770 of one embodiment.

### A First Group of Smart Tripod Features:

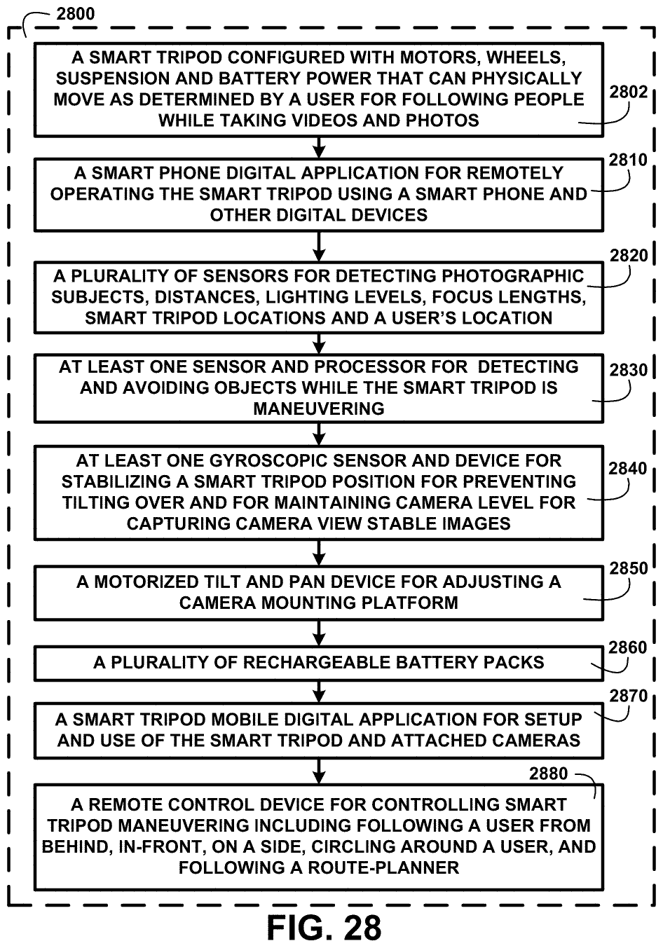

FIG. 28 shows a block diagram of an overview of a first group of smart tripod features of one embodiment. FIG. 28 shows a first group of smart tripod features 2800. The first group of smart tripod features 2800 includes a smart tripod configured with motors, wheels, suspension and battery power that can physically move as determined by a user for following people while taking videos and photos 2802, a smart phone digital application for remotely operating the smart tripod using a smart phone and other digital devices 2810, a plurality of sensors for detecting photographic subjects, distances, lighting levels, focus lengths, smart tripod locations and a user's location 2820, at least one sensor and processor for detecting and avoiding objects while the smart tripod is maneuvering 2830, at least one gyroscopic sensor and device for stabilizing a smart tripod position for preventing tilting over and for maintaining camera level for capturing camera view stable images 2840, a motorized tilt and pan device for adjusting a camera mounting platform 2850, a plurality of rechargeable battery packs 2860, a smart tripod mobile digital application for setup and use of the smart tripod and attached cameras 2870 and a remote control device for controlling smart tripod maneuvering including following a user from behind, in-front, on a side, circling around a user, and following a route-planner 2880 of one embodiment.

### A Second Group of Smart Tripod Features:

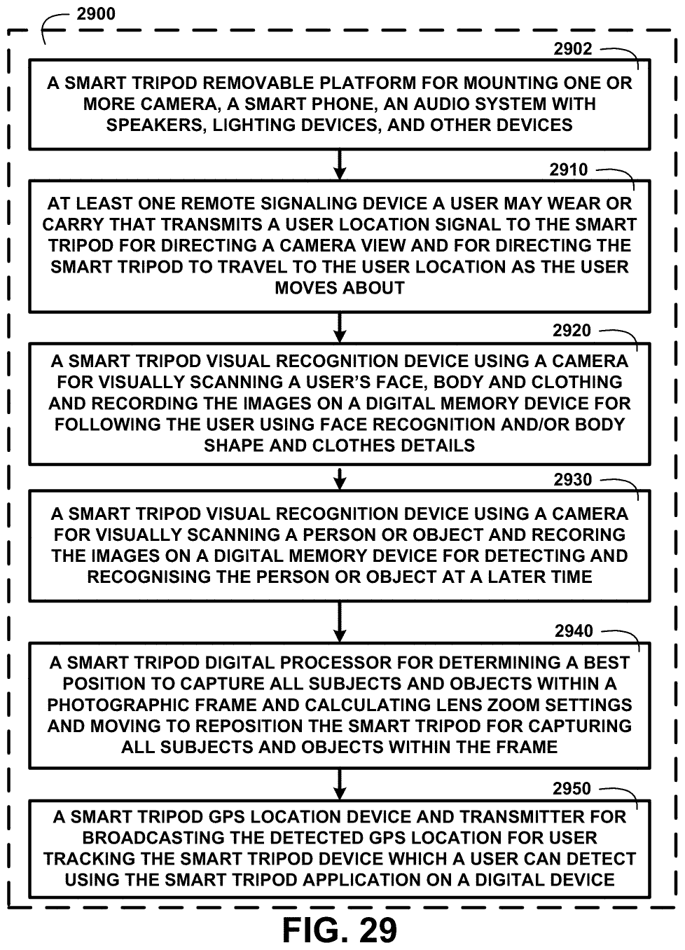

FIG. 29 shows a block diagram of an overview of a second group of smart tripod features of one embodiment. FIG. 29 shows a second group of smart tripod features 2900. The second group of smart tripod features 2900 includes a smart tripod removable platform for mounting one or more camera, a smart phone, an audio system with speakers, lighting devices, and other devices 2902, at least one remote signaling device a user may wear or carry that transmits a user location signal to the smart tripod for directing a camera view and for directing the smart tripod to travel to the user location as the user moves about 2910, and a smart tripod visual recognition device using a camera for visually scanning a user's face, body and clothing and recording the images on a digital memory device for following the user using face recognition and/or body shape and clothes details 2920 of one embodiment.

### A Third Group of Smart Tripod Features:

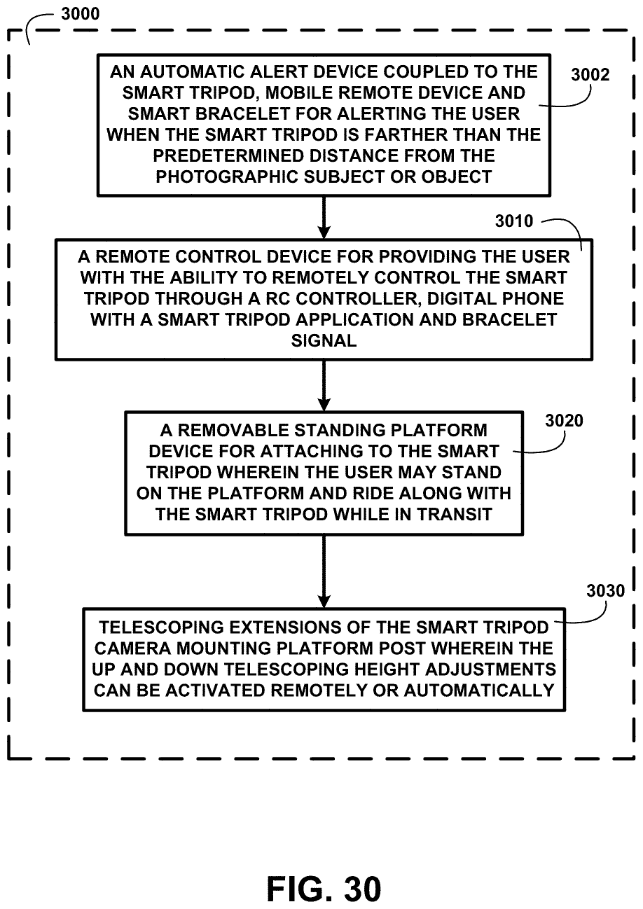

FIG. 30 shows a block diagram of an overview of a third group of smart tripod features of one embodiment. FIG. 30 shows a third group of smart tripod features 3000. The third group of smart tripod features 3000 includes an automatic alert device coupled to the smart tripod, mobile remote device and smart bracelet for alerting the user when the smart tripod is farther than the predetermined distance from the photographic subject or object 3002, a remote control device for providing the user with the ability to remotely control the smart tripod through an RC controller, digital phone with a smart tripod application and bracelet signal 3010, a removable standing platform device for attaching to the smart tripod wherein the user may stand on the platform and ride along with the smart tripod while in transit 3020 and telescoping extensions of the smart tripod camera mounting platform post wherein the up and down telescoping height adjustments can be activated remotely or automatically 3030 of one embodiment.

### A Fourth Group of Smart Tripod Features:

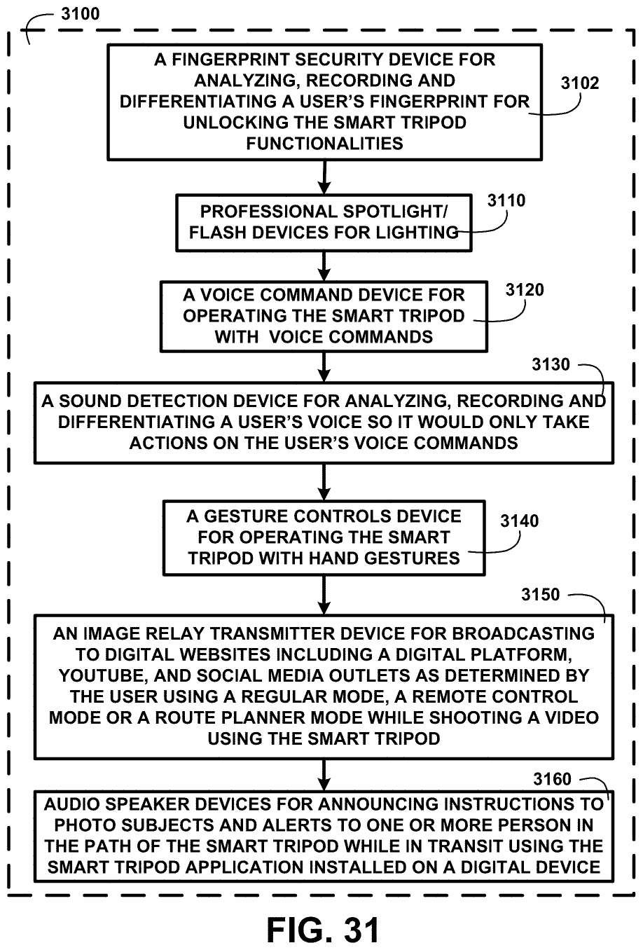

FIG. 31 shows a block diagram of an overview of a fourth group of smart tripod features of one embodiment. FIG. 31 shows a fourth group of smart tripod features 3100. The fourth group of smart tripod features 3100, a fingerprint security device for analyzing, recording and differentiating a user's fingerprint for unlocking the smart tripod functionalities 3102, professional spotlight/flash devices for lighting 3110, a voice command device for operating the smart tripod with voice commands 3120, a sound detection device for analyzing, recording and differentiating a user's voice so it would only take actions on the user's voice commands 3130, a gesture controls device for operating the smart tripod with hand gestures 3140, an image relay transmitter device for broadcasting to digital websites including a digital platform, YouTube, and social media outlets as determined by the user using a regular mode, a remote control mode or a route planner mode while shooting a video using the smart tripod 3150, and audio speaker devices for announcing instructions to photo subjects and alerts to one or more person in the path of the smart tripod while in transit using the smart tripod application installed on a digital device 3160 of one embodiment.

### Movable Luggage Integrated Telescoping Smart Tripod System:

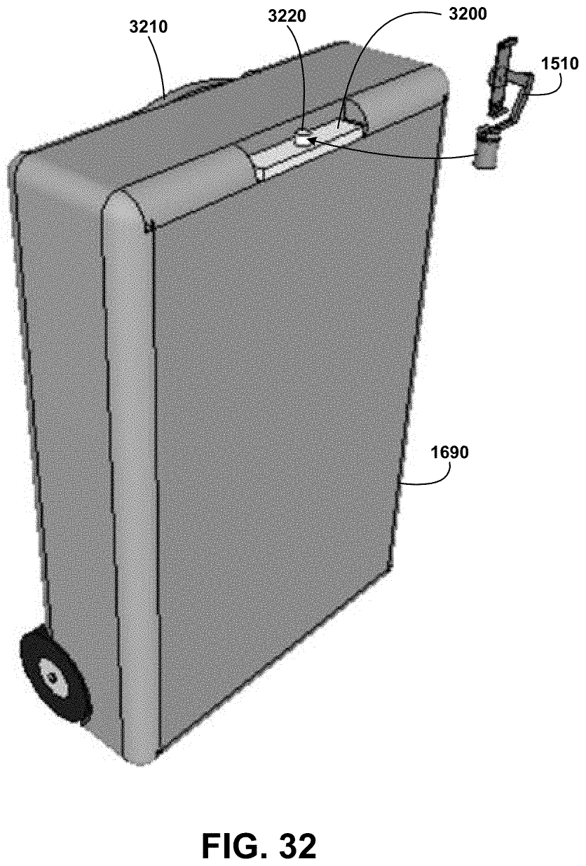

FIG. 32 shows for illustrative purposes only an example of a movable luggage integrated telescoping smart tripod system of one embodiment. FIG. 32 shows the self-propelled luggage apparatus 1690. A smart phone with camera 1505 of FIG. 15 may be mounted on the gimbal camera stabilizer 1510 that couples to a rotating gimbal camera stabilizer mounting connection 3220. When not in use the gimbal camera stabilizer 1510 may be stored inside the self-propelled luggage apparatus 1690. Also shown is a gimbal mounting platform 3200 with removable components not shown coupled inside of the gimbal mounting platform 3200 compartment. The removable components include at least one rechargeable lithium battery 1132 of FIG. 11B, a sensor array 1220 of FIG. 12B, a post rotation motor and gear device 2135 of FIG. 21, a GPS and electronics device 1860 of FIG. 18B, and sensors and digital control processor and memory device 1880 of FIG. 18B. Also shown is a movable luggage retractable handle 3210 of one embodiment.

### Movable Luggage Integrated Telescoping Smart Tripod Fully Telescoped:

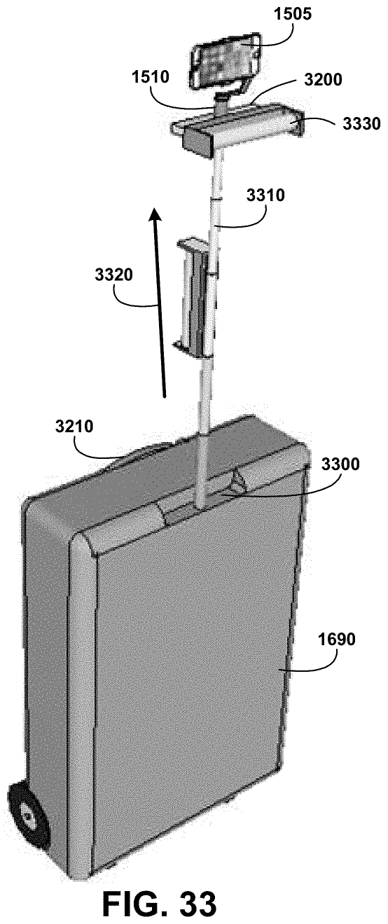

FIG. 33 shows for illustrative purposes only an example of a movable luggage integrated telescoping smart tripod fully telescoped of one embodiment. FIG. 33 shows the self-propelled luggage apparatus 1690 with the smart phone with camera 1505 mounted on the gimbal camera stabilizer 1510 atop the fully extended telescoping smart tripod 3310. The gimbal mounting platform 3200 has been pulled up 3320 from a gimbal mounting platform luggage recess 3300. FIG. 33 shows also shows the movable luggage retractable handle 3210. Also showing at least one lighting fixture 3330 coupled to the fully extended telescoping smart tripod 3310 of one embodiment.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

1. A method, comprising:
providing a smart tripod with user selected command signals and auto-drive on-board guidance controls including a physical tracking system to track an object and person with a steering system override element;
coupling the smart tripod to a self-propelled motorized drive systems including a track drive with articulated suspension;
providing the track drive with a plurality of a smart tripod telescoping leg with a telescoping track support to independently extend and retract each smart tripod telescoping leg and telescoping track support;
providing the smart tripod with coupling devices for attachment to an external self-propelled apparatus;
providing a movable luggage integrated telescoping smart tripod system;
operating the smart tripod with hand gestures using a gesture controls device;
providing smart tripod digital controllers to receive and transmit signals for responding to user transmitted signals and digital commands wirelessly for various operations including sound and voice recording;
providing a smart tripod visual recognition device using a camera for visually scanning a user's face, body and clothing and recording the images on a digital memory device for following the user using face recognition and/or body shape and clothes details;
providing a voice command device for operating the smart tripod with user voice commands;
coupling the smart tripod auto-drive on-board guidance controls to GPS maneuvering systems and obstacle and person recognition and avoidance systems; and
coupling the digital controllers to user face and voice recognition systems.

2. The method of claim 1, further comprising creating the self-propelled motorized drive systems includes systems configured to include one from a group of self-propelled motorized drive systems including a track drive system, a pneumatic wheel drive system, a small wheel drive and a self-propelled light-weight smart tripod system.

3. The method of claim 1, further comprising creating coupling devices for attachment of a smart tripod system to an external self-propelled apparatus may be configured to include one from a group of a removable smart tripod self-propelled luggage apparatus, a fixed smart tripod self-propelled luggage apparatus, and a removable personal scooter smart tripod foldable assembly.

4. The method of claim 1, further comprising creating on-board guidance controls are configured for including smart tripod sensor arrays.

5. The method of claim 1, further comprising creating on-board guidance controls are configured for including at least one smart tripod gimbal stabilizer system for stabilizing the smart tripod orientations and at least one gimbal camera stabilizer for stabilizing a camera mounting platform.

6. The method of claim 1, further comprising user selected command signals configured for using a smart tripod user location transponder for transmitting the user location in a GPS coordinate signal.

7. The method of claim 1, further comprising creating on-board guidance controls with remote control using a smart tripod application installed on a user digital device for controlling the operations of the smart tripod.

8. The method of claim 1, further comprising creating auto-drive on-board guidance controls configured to include a visual sensor, an infrared sensor and a motion detector for detecting obstacles in a smart tripod maneuvering pathway and determining a change in the path to avoid obstacles and people.

9. The method of claim 1, further comprising creating user selected command signals configured to include an audio system with speakers for broadcasting verbal command signals and configured to include lighting devices for responding to command signals to increase light levels for capturing photographic images.

10. The method of claim 1, further comprising using smart tripod digital controllers configured to include a plurality of sensors for detecting photographic subjects, distances, lighting levels, focus lengths, smart tripod locations and a user's location.

11. An apparatus, comprising:
a self-propelled smart tripod assembly including a motorized drive system including on-board guidance controls;
a plurality of a smart tripod telescoping legs with a telescoping track support to independently extend and retract each smart tripod telescoping leg and telescoping track support;
a smart tripod application configured to be installed on a user digital device for remotely controlling operations of the self-propelled smart tripod assembly;
a gesture controls device configured for operating the smart tripod with hand gestures;
a plurality of sensors and devices for receiving and transmitting sensor detected data to the user's digital device with the smart tripod application installed; and
wherein the plurality of sensors and devices detected data are used for evaluating and processing the detected data for controlling maneuvering and operating the smart tripod features.

12. The apparatus of claim 11, wherein the self-propelled motorized drive systems includes systems configured to include one from a group of self-propelled motorized drive systems including a track drive system, a pneumatic wheel drive system, a small wheel drive and a self-propelled light-weight smart tripod system.

13. The apparatus of claim 11, further comprising the plurality of sensors and devices are configured to include auto-drive on-board guidance controls configured to include a visual sensor, an infrared sensor and a motion detector for detecting obstacles in a smart tripod maneuvering pathway and determining a change in the path to avoid obstacles and people.

14. The apparatus of claim 11, further comprising the plurality of sensors and devices are configured to include an audio system with speakers for broadcasting verbal command signals and configured to include lighting devices for responding to user command signals to increase light levels for capturing photographic images.

15. The apparatus of claim 11, further comprising smart tripod coupling devices for attachment to an external self-propelled apparatus.

16. An apparatus, comprising:
at least one smart tripod assembly configured for self-propelled maneuvering;
a user stand-on platform configured to include a front track steering system, track drive motor, track drive with articulated suspension and track treads for allowing a user to ride on the at least one smart tripod assembly;
a plurality of digital devices for operating on-board guidance systems for maneuvering, receiving and responding to remote controls by a user;
wherein on-board guidance systems controls are configured to include auto-drive functions using a visual sensor, an infrared sensor and a motion detector for detecting obstacles in a smart tripod maneuvering pathway and determining a change in the path to avoid detected obstacles and people;
a sound detection device configured for analyzing, recording and differentiating a user's voice so it would only take actions on the user's voice commands;
a voice command device configured for operating the smart tripod with user voice commands; and
a user remote controlling smart tripod application is installed on a user digital device for remotely controlling the operations of the smart tripod assembly of features and devices wirelessly.

17. The apparatus of claim 16, wherein the plurality of digital devices are configured to include smart tripod digital controllers configured to include a plurality of sensors for detecting photographic subjects, distances, lighting levels, focus lengths, smart tripod locations, a user's location and user face and voice recognition systems.

18. The apparatus of claim 16, further comprising at least one smart tripod assembly configured to include one from a group of self-propelled motorized drive systems including a track drive system, a pneumatic wheel drive system, a small wheel drive and a self-propelled light-weight smart tripod system.

19. The apparatus of claim 16, further comprising at least one smart tripod gimbal stabilizer system for stabilizing the smart tripod orientations and at least one gimbal camera stabilizer for stabilizing a camera mounting platform.

20. The apparatus of claim 16, further comprising the plurality of digital devices for operating on-board guidance systems configured to include a front steering system, a rechargeable battery power system and a power distributor control device for distributing power to smart tripod electrical and electronic device including drive motors wherein the power distributor control device controls an amount of power and time duration of power transmitted to each drive motor for adjusting a speed and distance traveled by drive system while turning, circling, and up and down hill speeds.
